(19) United States
(12) Patent Application Publication
(10) Pub. No.: US 2015/0116343 A1
(43) Pub. Date: Apr. 30, 2015

(54) ELECTRONIC DEVICE AND IMAGE REPRODUCING CHARACTERISTICS DETERMINATION METHOD

(71) Applicants: Kabushiki Kaisha Toshiba, Tokyo (JP); Toshiba Lifestyle Products & Services Corporation, Tokyo (JP)

(72) Inventor: Atsushi Suzuki, Ome-shi (JP)

(21) Appl. No.: 14/463,044

(22) Filed: Aug. 19, 2014

(30) Foreign Application Priority Data
Oct. 28, 2013 (JP) 2013-223143

(51) Int. Cl. G06F 3/14; G09G 5/30

(52) U.S. Cl. CPC G06F 3/1446; G09G 5/30; G09G 2320/0626; G09G 2320/066; G09G 2320/0666; G09G 2320/08; G09G 2300/026
USPC 345/581

(57) ABSTRACT

According to one embodiment, an electronic device includes an image processor, a processor, and a controller. The image processor configured to determine a boundary of displays and images on both sides of the boundary from an image captured by an image capturer, and configured to extract a difference of image reproducing characteristics of the images of the both sides of the boundary. The processor configured to set an image reproducing characteristics setting value to change image reproducing characteristics of the image on one side of the boundary extracted by the image processor. The controller configured to supply the image reproducing characteristics setting value to one of the display devices through a network.

### CROSS-REFERENCE TO RELATED APPLICATIONS

This application is based upon and claims the benefit of priority from Japanese Patent Application No. 2013-223143, filed Oct. 28, 2013, the entire contents of which are incorporated herein by reference.

### FIELD

Embodiments described herein relate generally to an electronic device configured to display an image on a display device on which a plurality of display panels are arranged in parallel and an image reproducing characteristics determination method.

### BACKGROUND

In an electronic device such as a display apparatus in which a panel-shaped display part is used as an image display part, an image may be displayed using a plurality of display panels arranged in parallel.

When a plurality of display panels are arranged for displaying an image, image reproducing characteristics, for example, brightness, contrast, tint and hue may vary at a joint part of the panels due to viewing angle difference or individual difference between the panels. Especially, when panels with difference viewing angles in first and second directions orthogonal to each other are used, differences in the brightness and hue are easily recognizable at a boundary of the panels connecting each other in a direction in which the difference in the viewing angle is remarkable. Note that, when a single image is divided into a plurality of images by a plurality of panels to, for example, enlarge the image, the differences in the brightness and hue between the panels are especially recognizable at the boundary of the panels.

To remove the differences in the image reproducing characteristics, for example, brightness, contrast, tint and hue between the panels, it is generally performed to, for example, set an adjustment value (correction amount) acquired based on display of each panel, display a display image to which the adjustment value is reflected, set a new adjustment value acquired based on the display image to which the adjustment value is reflected, display a display image to which the new adjustment value is reflected, and repeat the above for several times. If the number of panels is large, the adjustment process becomes highly complicated.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 illustrates a schematic example of a system structure of the embodiments;

FIG. 2 illustrates a schematic example of a system structure of the embodiments;

FIG. 3 illustrates an example of adjustment of display devices in the system of the embodiments;

FIG. 4 illustrates a software-performable adjustment method of the display devices in the system of the embodiments; and

FIG. 5 illustrates an example of the display devices applicable to the system of the embodiments.

### DETAILED DESCRIPTION

Various embodiments will be described hereinafter with reference to the accompanying drawings.

In general, according to one embodiment, an electronic device comprises an image processor, a processor, and a controller. The image processor configured to determine a boundary of displays and images on both sides of the boundary from an image captured by an image capturer, and configured to extract a difference of image reproducing characteristics of the images of the both sides of the boundary. The processor configured to set an image reproducing characteristics setting value to change image reproducing characteristics of the image on one side of the boundary extracted by the image processor. The controller configured to supply the image reproducing characteristics setting value to one of the display devices through a network.

Hereinafter, one of the present embodiments is described with reference to the drawings.

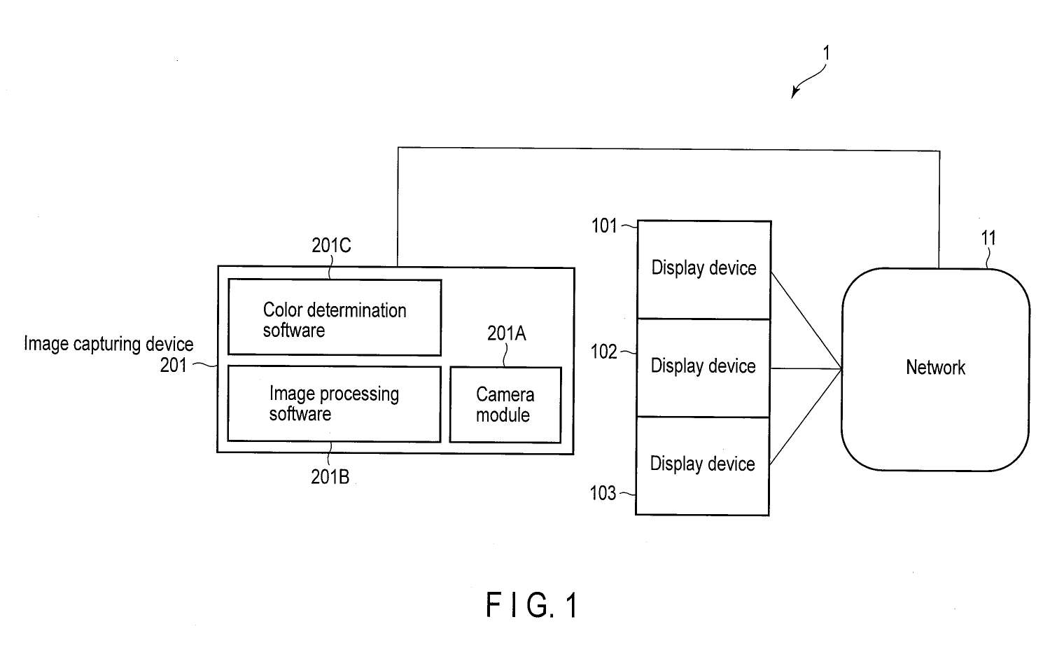

FIG. 1 illustrates an electronic apparatus (display system) 1 including, for example, a plurality of display devices 101 to 103, an image capturing device, for example, a camera, a portable terminal with a camera module or personal (tablet) computer with a camera (element) 201, and network 11 connecting these devices.

The display devices 101 to 103 are configured to receive an input of an image signal and display the whole or a part of the input image signal. The display devices 101 to 103 are, for example, smart televisions (television receivers) having communication and control functions using network link function such as WebSocket. Each of the display devices 101 to 103 is configured to receive and reproduce, for example, an ordinary television broadcast.

The image capturing device or tablet computer 201 comprises a camera module 201A having capturing function to capture an image, image processing software (image processor) 201B having extraction function to extract an edge (image) to which any of the display devices 101 to 103 is connected from the image input from the camera part, and color determination software (image quality determination and setting part) 201C to extract color information at a region including the extracted edge. The image capturing device or tablet computer 201 is, for example, a tablet terminal device or a portable terminal device with the capturing function (photographing function) to capture an image.

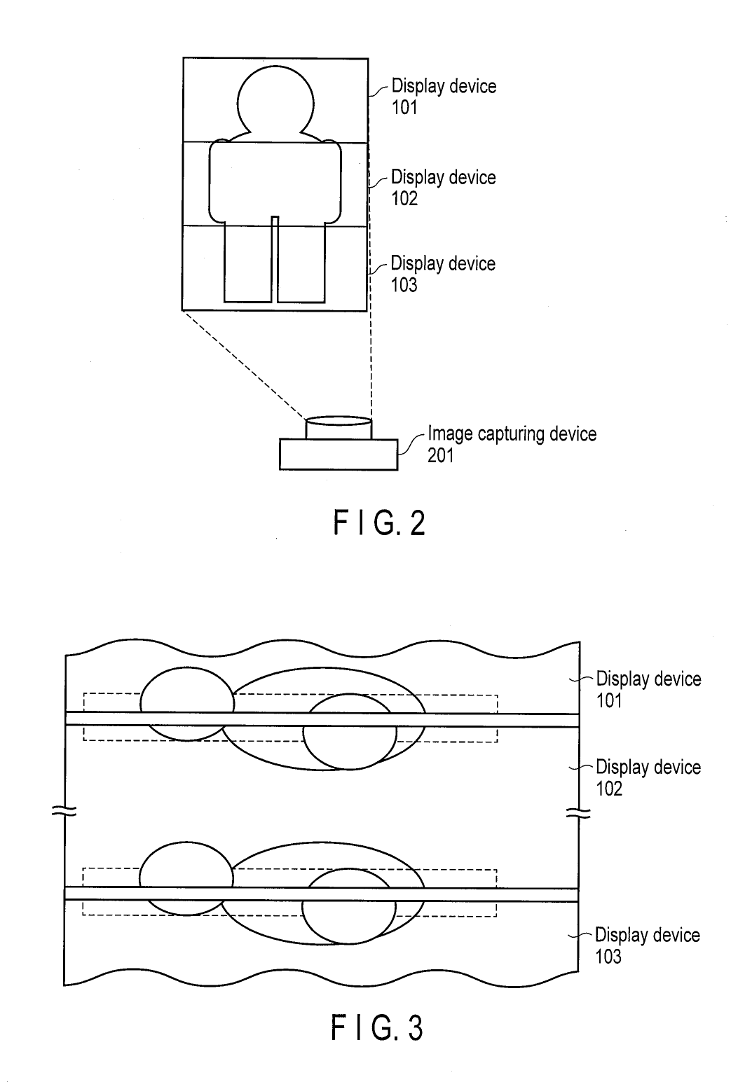

FIG. 2 schematically illustrates the image capturing device 201 to capture an image of an image displays the display devices 101 to 103 of the display system (electronic apparatus) 1 shown in FIG. 1.

In the example of FIG. 2, a single image is enlarged and displayed by the three display devices 101 to 103 aligned in a single-file line. Here, four display devices arranged in a 2 by 2 matrix or six display devices arranged in a 3 by 2 matrix may be used to display the same instead of the aligned three devices.

The image displayed by the display devices 101 to 103 aligned as in FIG. 2 is captured by the image capturing device 201 (camera module 201A). As in an example shown in FIG. 3, the image capturing device 201 extracts an edge (image) in which any of the display devices 101 to 103 contact another using image processing software 201B, and then acquires an adjustment value (correction value) of brightness and hue, etc. using color determination software 201C. The image capturing device 201 then supplies the adjustment value (correction amount) to the display devices 101 to 103 through the network 11.

FIG. 3 illustrates a display example of an image photographed by the image capturing device 201 in which edges (boundary areas) of two display images of the adjacent display devices such as display devices 101 and 102 (or display devices 102 and 103) contact each other.

When displaying edges (boundary areas) of display images, a difference in, for example, brightness, contrast, tint and hue may be emphasized due to an individual difference between the display devices 101 and 102 (or 102 and 103).

To minimize the difference in the image reproducing characteristics of the display images such as brightness, contrast, tint and hue, the boundary areas between the display devices 101 and 102 (the image of the edge of display device 101 and the image of the edge of display device 102) is photographed and analyzed by the image processing software 201B, and the adjustment value (correction amount) is acquired using the color determination software 201C. Note that the adjustment value is acquired from other boundary areas, that is, in the example of FIG. 3, the adjustment value of the boundary areas between the display devices 102 and 103 is acquired in the same manner.

Furthermore, in a case where each of the display devices 101 to 103 is an LCD panel, the panels may be connected to each other in direction in which the image reproducing characteristics, for example, at least on of brightness, contrast, tint and hue variation (difference) with respect to viewing angle difference is quite remarkable. Thus, the above adjustment process to acquire the adjustment value may be repeated for several times (such an adjustment process repeated for several times is essential in most cases).

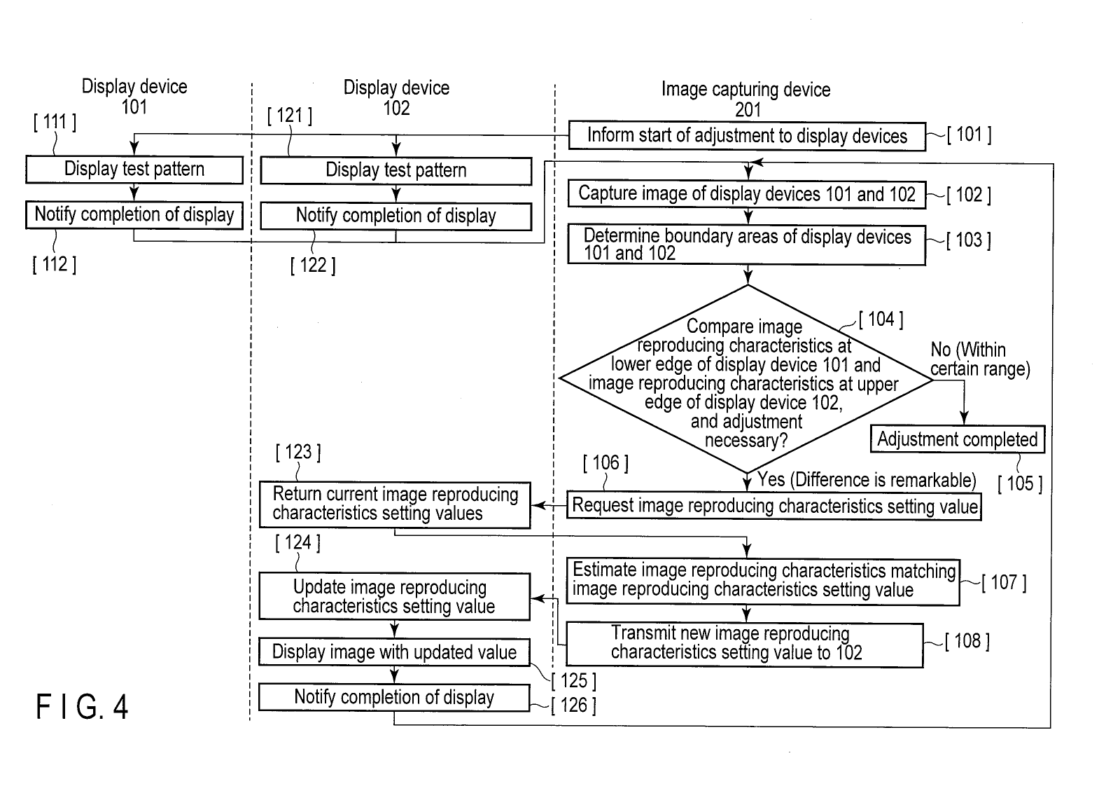

FIG. 4 illustrates a process flow carried out in the device of the present embodiment.

Firstly, the image capturing device (tablet terminal) 201 notifies starting an adjustment (adjustment process) to each of the display devices 101 to 103 [101]. Here, the adjustment process performed between the display devices 101 and 102 and the adjustment process performed between the display devices 102 and 103 are performed similarly, and thus, the adjustment between the display devices 101 and 102 is mainly explained below referring to FIG. 4.

Each of the display devices 101 and 102 displays a test pattern image corresponding to test pattern information (image data) received form the tablet terminal (image capturing device) 201 [111], [121].

Each of the display devices 101 and 102 notifies the tablet terminal 201 that the display of test pattern image has been completed [112], [122].

The tablet terminal 201 captures (photographs/picks up) the display image displayed by the display system 1 (display devices 101 and 102) at a certain point of time after receiving the notice of completion of the display of test pattern image (the photographed image here may include the display of test pattern image displayed by the display device 103). Here, the vicinity of at least the edge of the display of the test pattern image displayed by the display device 101 (the edge adjacent to the test pattern image displayed by the display device 102) and the edge of the display of the test pattern image displayed by the display device 102 (the edge adjacent to the test pattern image displayed by the display device 101) is captured (photographed/picked up) as a test pattern image of the edges (boundary areas) [102].

Then, from the test pattern image captured by the tablet terminal 201, the edge of the display of the test pattern image displayed by the display device 101 (the edge adjacent to the test pattern image displayed by the display device 102) and the edge of the display of the test pattern image displayed by the display device 102 (the edge adjacent to the test pattern image displayed by the display device 101) are determined (detected) [103].

Next, the image reproducing characteristics (image characteristics), for example, at least one of brightness, contrast, tint and hue, of the test pattern images of the detected two edges (the edge of the test pattern image of the display device 101 side displayed by the display device 102 and the edge of the test pattern image of the display device 102 side displayed by the display device 101), that is, at least one of brightness, contrast, tint and hue, etc. are extracted. The extracted characteristics are compared to each other in a same image characteristic to check a difference, and examined if the difference is within a certain range (within a permissible range) to determine if there is a necessity of adjustment [104].

If the difference in all of brightness, contrast, tint and hue, etc extracted from the images are within a certain range (within a permissible range), that is, if there is no necessity of adjustment [104-NO], the adjustment of boundary areas of the display of display device 101 and the display of display device 102 is terminated (the tablet terminal 201 instructs the termination of adjustment to each display device) [105]. Note that the adjustment of the boundary areas of the display image of display device 102 and the display image of display device 103 is performed next; however, what is performed therein is substantially the same adjustment process, and thus, the detailed explanation thereof is omitted.

If the difference in at least one of brightness, contrast, tint and hue, etc. extracted from the images is out of a certain range (out of a permissible range), that is, if there is a necessity of adjustment [104-YES], the tablet terminal 201 requests either the display device 101 or 102 (to the display device 102 in FIG. 4) to transmit an image reproducing characteristics setting value (at least one of brightness, contrast, tint and hue) of the image currently being displayed [106].

If the display device 102 receives the request to transmit the image reproducing characteristics setting value, the display device 102 transmits a current image reproducing characteristics setting value to the tablet terminal 201 [123].

The tablet terminal 201 uses the image reproducing characteristics setting value transmitted from the display device 102 and estimates an image reproducing characteristics setting value by which the image qualities of the edge of the display device 101 and the adjacent edge of the display device 102 are estimated to correspond each other. The expected image reproducing characteristics setting value(s) is(are) one or both of brightness and hue, contrast, and the like [107].

The tablet terminal 201 transmits (instructs) a new image reproducing characteristics setting value to the display device (display device 102) [108].

After receiving the new image reproducing characteristics setting value, the display device (display device 102) updates the current image reproducing characteristics setting value to the received new image reproducing characteristics setting value [124], displays a test pattern image using the new image reproducing characteristics setting value [125], and notifies the tablet terminal 201 that the display has been completed (sends notification) [126].

After receiving the completion of display (notification) from the display device (display device 102), the tablet terminal 201 photographs an image displayed by the display system 1 (display devices 101 and 102) at a certain point of time [102].

From then on, the above-described display image detection ([103]) and extraction of image characteristics to determine if there is a necessity of adjustment ([104]) are repeated until the difference in the extracted brightness and hue, etc falls under a certain range (within a permissible range) or until the adjustment is repeated for the predetermined number of times ([105]) to obtain uniform image reproducing characteristics in the image displayed by the display devices 101 to 103.

Note that, in the display image reproducing characteristics adjustment in the display system described above, the arrangement of display devices may be chosen optionally, and a method to detect edges of display images or boundaries between the displays of the display devices may also be chosen optionally (may be determined by visual observation by a user (eyesight determination) or may be automatically determined by a determination program).

Furthermore, the tablet terminal 201 may photograph a display image by a user's manual operation and may photograph automatically at any timing after the tablet terminal 201 has received the notice of completion of displaying the test pattern image. Note that, preferably, a plurality of test pattern images are photographed considering the display characteristics of the display devices (such as image rewrite [image frame update] and backlight blink [drive circuit characteristics], etc.) for selecting the brightest image therefrom to be used in the determination of the image reproducing characteristics. Or, a plurality of image frames of display images are photographed for calculating an integral value (or an average value) therefrom to be used in the determination of the image reproducing characteristics.

Note that, if the tablet terminal 201 requests the transmission of image reproducing characteristics setting value for setting the image reproducing characteristics (at least one of brightness, contrast, tint and hue) of the image currently being displayed with respect to either the display device 101 or the display device 102 whichever has less adjacent display devices, an influence of the image reproducing characteristics adjustment between display devices may be suppressed.

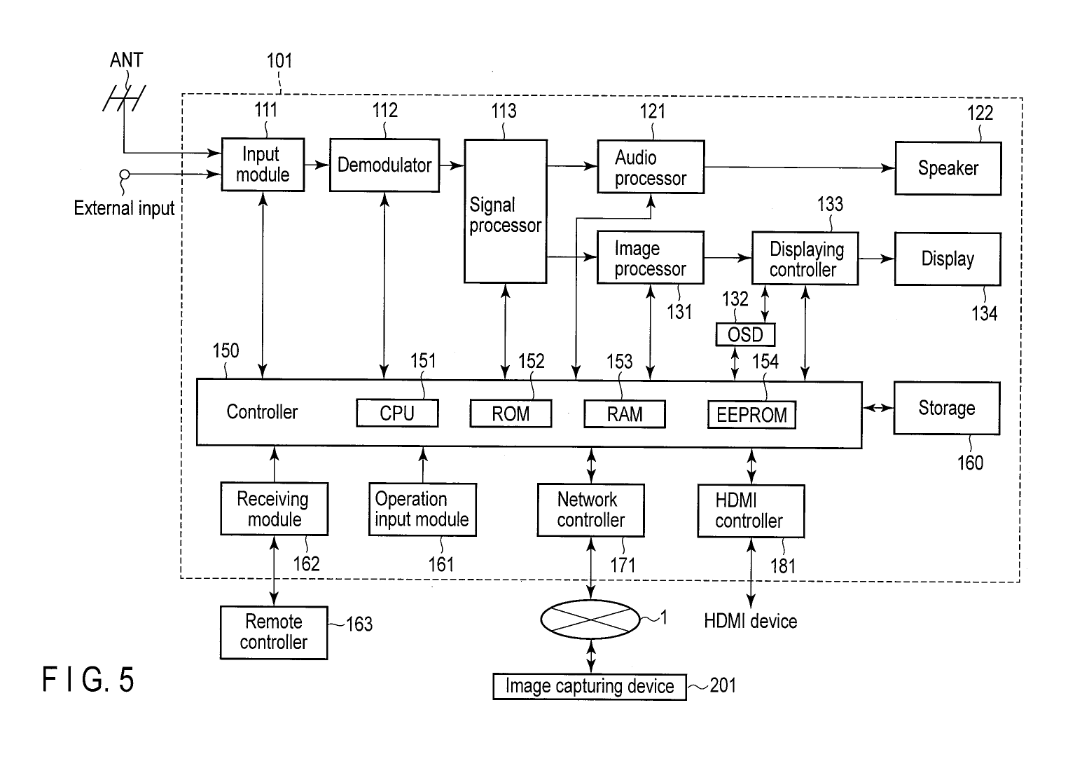

Note that the display device (electronic apparatus) 1 shown in FIGS. 1 to 3 is not limited to a television apparatus as shown in FIG. 5 and may be any device or apparatus configured to display an image. For example, the display device (electronic apparatus) 1 may be a personal computer (PC) configured to receive broadcasts, image display device (monitor device) connected to an image recording device (recorder) having a broadcast receiving device, and mobile terminal device having a broadcast reception function. The image here includes any one of or any optional combination of motion picture, still image, and text (characters represented by coded strings and information represented by symbols) contained in broadcasts brought by a broadcaster (broadcast station) through radio wave. Furthermore, the image here includes those are distributed by a distributer through an optical fibered cable system and network such as internet protocol (IP) net. The image here further includes video, audio, and/or music provided in a program which is broadcast for a certain period of time (broadcast time), and the programs are provided in series or for a certain period of time. The image here may be referred to as a content, stream, or program.

FIG. 5 shows an example of elements of a television apparatus applicable to the display device (each of display devices 101 to 103) of the display system shown in FIGS. 1 to 4.

The television apparatus 101 (102 and 103 may be the same apparatus) includes an input module 111, demodulator 112, signal processor 113, audio processor 121, image processor 131, ODS processor 132, displaying controller 133, controller 150, storage 160, operation input module 161, receiving module 162, network controller 171 and HDMI controller 181.

The television apparatus 101 receives a control input (operation instruction) from, for example a remote controller 163 and supplies a control command corresponding to the control input (operation instruction) to the controller 150. For example, if a power button is pressed, the apparatus turns into an activation mode from a standby mode (waiting/main power off mode), and if the power button is pressed again, the apparatus turns into the standby mode from the activation mode.

The input module 111 receives digital broadcast signals receivable through, for example, an antenna ANT. The digital broadcast signals are, for example, terrestrial broadcast signals, broadcasting satellite (BS) broadcast signals, and/or communication satellite (CS) broadcast signals. The input module 111 may receive, for example, contents (external inputs) supplied through a set top box (STB: an external tuner corresponding to scramble broadcast, or channel selector configured to select broadcasts distributed by cable distributer) or contents supplied directly from an external device.

The input module 111 performs tuning of the received digital broadcast signals (selection of station). The input module 111 supplies the tuned digital broadcast signal to the demodulator 112. The input module 111 may include a plurality of tuners. In that case, the television apparatus receives a plurality of digital broadcast signals/contents at the same time. Note that the input module 111 supplies the external inputs through the STB to the demodulator 112 without performing any tuning.

The demodulator 112 demodulates the selected broadcast signals/contents. That is, the demodulator 112 acquires motion picture data such as transport stream (TS) and the like (hereinafter, the motion picture data is referred to as stream). The demodulator 112 inputs the acquired stream into the signal processor 113. Note that the television apparatus 101 may include a plurality of demodulators 112. The demodulators 112 demodulate the digital broadcast signals/contents, respectively.

The signal processor 113 separates the stream demodulated by the demodulator 112 into, for example, audio components and image components, and character information and data components for electronic program guide (EPG). That is, the signal processor 113 divides the stream into digital image signals, digital audio signals, and the other data signals including the above-mentioned EPG components and text data indicated by characters and symbols for a service called data broadcast. Note that the signal processor 113 may separate a plurality of streams demodulated by the demodulators 112 respectively.

The signal processor 113 supplies the digital audio signals separated from the stream to the audio processor 121. Furthermore, the signal processor 113 supplies the digital image signals separated form the stream to the image processor 131. Furthermore, the signal processor 113 supplies the data signals such as data for EPG to the controller 150.

Here, the signal processor 113 may convert the stream into recordable data (record stream) based on a command from by the controller 150. The signal processor 113 may supply the record stream to the storage 160 or to the other modules based on a command from the controller 150.

Moreover, the signal processor 113 may convert (transcode) the bit rate of the stream originally set in the broadcast signals/contents into the other bit rate. That is, the signal processor 113 may transcode (convert) the original bit rate of the acquired broadcast signals/contents into the lower bit rate. Thus, the contents (programs) can be recorded while saving the storage volume.

The audio processor 121 converts the digital audio signals from the signal processor 113 into signals (audio signals) of playable format by the speaker 122. That is, the audio processor 121 includes a digital-to-analog (D/A) converter and converts the digital signal into analog audio (acoustic)/voice signals. The audio processor 121 supplies the converted audio (acoustic)/voice signals to the speaker 122. The speaker 122 plays back the voice and sound based on the audio (acoustic)/voice signals.

The image processor 131 converts the digital image signals from the signal processor 113 into image signals in a playable format by the display 134. That is, the image processor 131 decodes the digital image signals from the signal processor 113 into image signals in a playable format by the display 134. The image processor 131 outputs the decoded image signals to the displaying controller 133.

The OSD processor 132 generates on-screen display (OSD) signals used to superpose various displays such as graphical user interface (GUI), caption, and time upon the display signals from the image processor 131 based on the data signals supplied from the signal processor 113 and/or control signals supplied from the controller 150.

The displaying controller 133 performs the image quality adjustment process including adjustments of tint, brightness, sharpness, contrast and the like of the image signals based on a command from the controller 150, for example. The displaying controller 133 supplies the adjusted image signals to the display 134. Thus, the display 134 can display the image based on the adjusted image signals.

The displaying controller 133 further superposes the OSD signals form the OSD processor 132 upon the adjusted display signals from the image processor 131, and supplies the superposed signals to the display 134.

The display 134 includes a liquid crystal display panel having a plurality of pixels arranged in a matrix form and a backlight to illuminate the liquid crystal panel, etc. The display 134 displays an image based on the image signals supplied from the displaying controller 133.

Here, the television apparatus 101 may include, instead of the display 134, an output terminal to output the image signals. Furthermore, the television apparatus 101 may include, instead of the speaker 122, an output terminal to output the audio signals. The television apparatus 101 may include an output terminal to output both digital image and digital audio signals.

The controller 150 controls function of each module of the television apparatus 101. The controller 150 includes a central processing unit (CPU) 151, read-only memory (ROM) 152, random access memory (RAM) 153, and non-volatile memory (EEPROM) 154, etc. The controller 150 performs various processes based on operation signals from the operation input module 161.

CPU 151 includes an operation device and the like to execute various operations. The CPU 151 performs various functions by executing the programs stored in ROM 152 and EEPROM 154, etc.

The ROM 152 stores programs to control the television apparatus 101 and programs to achieve various functions. The CPU 151 activates the programs stored in the ROM 152 based on the operation signals from the operation input module 161. With the activated programs, the controller 150 controls the function of each module.

The RAM 153 functions as a work memory of the CPU 151. That is, the RAM 153 stores operation results from the CPU 151 and data read by the CPU 151, etc.

The EEPROM 154 is a non-volatile memory to store the information of various settings and programs. Here, the EEPROM 154 stores information of a client device authenticated by a Wi-Fi direct processor (not shown) as the need arises (based on a command of the controller 150).

The storage 160 includes a storage medium to store the contents. The storage 160 is, for example, a hard disk drive (HDD), solid state drive (SSD), and semiconductor memory. The storage 160 may store the record stream and text data supplied from the signal processor 113.

The operation input module 161 includes, for example, an operation key to generate operation signals in response to the operation input by a user. The operation input module 161 may have a configuration to receive operation signals from keyboard, mouse, and other input devices to generate operation signals. The operation input module 161 supplies the operation signals to the controller 150.

Note that the display 134 of the television apparatus 101 may include a touchpanel function to substitute a part of the functions of the operation input module 161.

The receiving module 162 includes a sensor to receive the operation signals from the remote controller 163 supplied through infrared ray (Ir) method. The receiving module 162 supplies the received signals to the controller 150. The controller 150 receives the signals from the receiving module 162, amplifies the received signals, and performs the A/D conversion to decode the original operation signals transferred from the remote controller 163.

The remote controller 163 generates operation signals based on the user's operation input. The remote controller 163 transmits the generated operation signals through infrared communication. Note that receiving module 162 and the remote controller 163 may receive/transmit the operation signals through other wireless communication such as radio wave (RF) and the like.

The network controller 171 may connect to, for example, a network (Internet) 1 to communicate with other devices on the network 1. The television apparatus 101 can receive/transfer information from/to any devices, contents providers, and various data servers connectable through the network 1. The television apparatus 101 can acquire contents (streams) provided from contents providers, data servers, or any home devices which are connected through the network controller 171, and reproduce the contents (streams). Note that the network controller 171 includes communication and control functions using Websocket as, for example, software or intra-controller structure. The Websocket is an interface configured to receive/transmit control signals from/to the network. The communication and control functions using the Websocket may be provided as firmware operable by the CPU 151 of the controller 150 through, for example, plug-in method.

The HDMI controller 181 conforms to High Definition Multimedia Interface (HDMI) (registered trademark) standard and receives/transmits control signals, image (video) data, and voice (acoustic/audio) data from/to an external device. The HDMI controller 181 receives/transmits contents (streams) including image and voice from/to an external device or mass-storage memory (external HDD) having an HDMI terminal. The external device may be, for example, a Blue-ray (registered trademark) recorder, digital versatile disk (DVD) recorder, hard disk (HDD) recorder, other device conforming to HDMI standard (HDMI device), and network attached storage (NAS). Note that the television apparatus 101 may include other interface such as a LAN terminal connected to, for example, Serial-Advanced Technology Attachment (Serial-ATA) and HDMI Ethernet Channel (HDMI-HEC) (registered trademark), etc.

As can be understood from the above, according to the embodiments, when an image is shown by a plurality of display panels (display devices) arranged arbitrarily, changes in at least one of brightness, contrast, tint and hue, etc., which may occur at joint parts of the panels due to differences in viewing angle of the panels can be reduced. Especially, when panels whose viewing angles in first and second directions orthogonal to each other are different are used to display an image, the setting value to uniform the image reproducing characteristics of the display devices (panels) can be derived from the angles.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a receiver configured to receive an instruction from an image processor;
a transmitter configured to, if the instruction is for a setting value of an image currently being displayed, transmit the setting value to the image processor; and
a processor configured to, if the instruction is for changing the setting value, change the setting value to be output to a display based on a first setting value in the instruction.

2. The electronic device of claim 1, wherein the receiver configured to receive the instruction through a network, and the transmitter configured to transmit the setting value through the network.

3. The electronic device of claim 2, wherein the receiver and the transmitter are interfaces to the network and configured to receive/transmit image data and control signal from/to the network.

4. An electronic device comprising:
an image processor configured to determine a boundary of displays and images on both sides of the boundary from an image captured by an image capturer, and configured to extract a difference of image reproducing characteristics of the images of the both sides of the boundary;
a processor configured to set an image reproducing characteristics setting value to change image reproducing characteristics of the image on one side of the boundary extracted by the image processor; and
a controller configured to supply the image reproducing characteristics setting value to one of the display devices through a network.

5. The electronic device of claim 4, wherein the controller transmits the image reproducing characteristics setting value on the network in such a manner that the image reproducing characteristics setting value is readable by the one of the display devices.

6. The electronic device of claim 4, wherein the processor estimates the image reproducing characteristics setting value by which image reproducing characteristics of the images on both sides of the boundary extracted by the image processor are estimated to correspond with each other.

7. The electronic device of claim 5, wherein the processor estimates the image reproducing characteristics setting value by which image reproducing characteristics of the images on both sides of the boundary extracted by the image processor are estimated to correspond with each other.

8. An image reproducing characteristics determination method of an electronic device, comprising:
determining a boundary of captured images of display devices and images on both sides of the boundary;
extracting a difference of image reproducing characteristics of the images on the both sides of the determined boundary;
setting an image reproducing characteristics setting value to change image reproducing characteristics of the image on one side of the determined boundary; and
supplying the image reproducing characteristics setting value to one of the display devices through a network.
